(19) United States
(12) Patent Application Publication
(10) Pub. No.: US 2020/0400212 A1
(43) Pub. Date: Dec. 24, 2020

(54) INERTIAL TRANSMISSION DEVICE

(71) Applicant: KABO TOOL COMPANY, Taichung City (TW)

(72) Inventor: Chih-Ching HSIEH, Taichung City (TW)

(21) Appl. No.: 16/867,903

(22) Filed: May 6, 2020

(30) Foreign Application Priority Data
Jun. 19, 2019 (TW) 108121364

(51) Int. Cl. F16F 15/30; B25B 23/00

(52) U.S. Cl. CPC F16F 15/30; B25B 21/00; B25B 23/0035

(57) ABSTRACT

The present invention relates to an inertial transmission device comprising a center element having an axial direction and two ends, one of the ends is a driving end and the other end is an output end, the center element is capable of rotating with the axial direction as a center; and an inertial element having a connecting portion and an inertial portion located at an outer edge of the connecting portion, an inner edge of the connecting portion is connected to the center element, and the inertial portion is closer to the output end of the center element than other portions of the inertial element. Thereby, rotational inertia of the inertial transmission device is close to the output end of the center element.

### BACKGROUND OF THE INVENTION

### Field of Invention

The present invention relates to a transmission device, and more particularly to an inertial transmission device that provides rotational inertia.

### Related Art

Hand-held power tools, such as pneumatic wrenches or electric wrenches, need to cooperate with a socket to rotate screwed components, when the screwed components such as bolt and nut are to be rotated. In order to increase the torque of the power tool and the socket tightening or loosening the screwed components, please refer to FIG. 1. At present, a common technical means is to make a disc 91 with a large outer diameter at an outer periphery of a socket 90 to form a socket with inertia effect, and a rotational inertia is generated by the disc 91 with a large outer diameter to generate a larger torque. The socket 90 is disposed with a driving end 92 and an output end 93 at two ends respectively. The driving end 92 is connected to a tool T, and the output end 93 is connected to a workpiece B. In order to effectively apply a moment of inertia generated by the disc 91 to the workpiece B, it is appropriate to design the disc 91 near the output end 93 of the socket 90.

Although the socket 90 with inertia design described above can generate a large torque, however, in some cases, as shown in FIG. 1, the workpiece B is located in a groove, because the disc 91 is protrudingly disposed on the outer periphery of the socket 90, in order to generate a moment of inertia closer to the workpiece B, the disc 91 is abutted on a peripheral portion A outside the workpiece B, the output end 93 of the socket 90 being unable to be fully connected with the workpiece B. Instead, a general socket is required for operation. In this case, when the operator rotates the workpiece B with different tightening requirements, the operator needs to repeatedly switch between using the general socket and the socket with inertial design. Such repeated switching of the sockets appears to be time-consuming and inconvenient in operation, even under certain conditions, switching between the sockets is not convenient.

### SUMMARY OF THE INVENTION

An object of the present invention is to provide an inertial transmission device, the inertial transmission device has an inertial portion with a large mass for providing a moment of inertia (rotational inertia). The inertial portion is close to an output end of the inertial transmission device, so that the moment of inertia of the inertial portion is capable of being exerted to the output end more effectively.

Another object of the present invention is to provide the above-mentioned inertial transmission device, so that the inertial portion is directed toward the output end of the inertial transmission device, and the problem that the inertial transmission device is affected by an operating environment can be reduced.

Yet another object of the present invention is to provide the above-mentioned inertial transmission device capable of reducing contact with the inertial portion by an operator and providing operation safety.

An inertial transmission device provided by the present invention includes:

a center element having an axial direction and two ends, one of the ends is a driving end and the other end is an output end, the center element is capable of rotating with the axial direction as a center; and an inertial element having a connecting portion and an inertia portion, the connecting portion is an annular body having an inner edge and an outer edge, the inner edge is connected to the center element, the inner edge and the outer edge have a positional difference, in the axial direction of the center element, the outer edge of the connecting portion is closer to the output end of the center element than the inner edge, and the inertia portion is disposed at the outer edge of the connecting portion.

Thereby, the inertia portion is disposed close to the output end of the inertial transmission device, so that a moment of inertia of the inertia portion is close to the output end, causing the moment of inertia to be exerted to the output end more effectively and without loss, so that the output end drives a workpiece with a larger moment of inertia (rotational inertia).

In addition, a connection position (that is, the inner edge of the connecting portion) between the connecting portion of the inertia element and the center element is relatively far away from the output end, thereby the inertia element reduces the interference during operating, and causing the output end of the center element to be capable of reaching deeper into the operating environment.

In addition, the inertial element extends toward the output end, which can reduce mistouch with the inertial element by an operator during operation and improve the safety of operation.

Preferably, a periphery of the inertia portion protrudes from a disc surface of a side of the connecting portion, and protrudes in a direction toward the output end of the center element.

Preferably, the inertia portion is ring-shaped, and annularly disposed at the outer edge of the connecting portion.

### BRIEF DESCRIPTION OF THE DRAWINGS

The objects, features and efficacies of the present invention can be understood from the description of the following preferred embodiments:

FIG. 1 is a schematic diagram of the state of use of a conventional inertia socket;

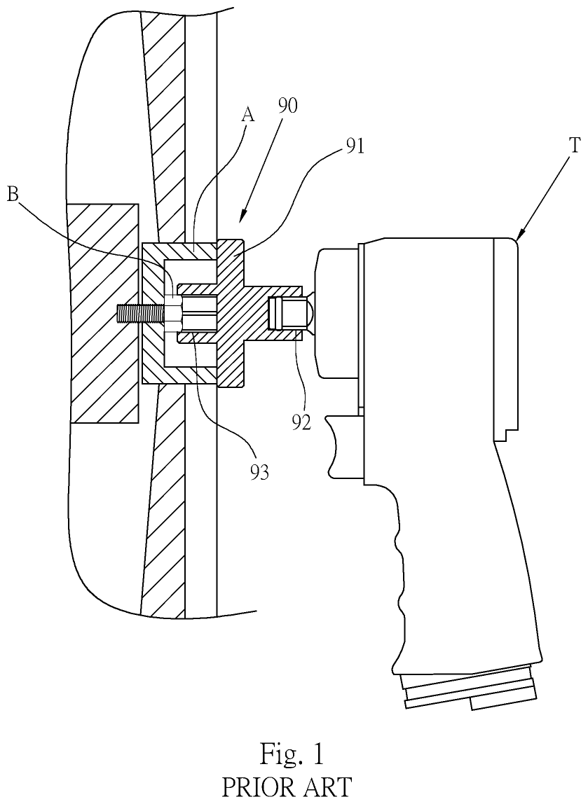

FIG. 2 is a perspective view of an inertial transmission device according to a first preferred embodiment of the present invention;

FIG. 3 is a sectional view taken along section line 3-3 of FIG. 2;

FIG. 4 is a side view of the operation of the inertial transmission device of the present invention;

FIG. 5 is a longitudinal sectional view of the inertial transmission device according to a second preferred embodiment of the present invention; and

FIG. 6 is a perspective view of the inertial transmission device according to a third preferred embodiment of the present invention.

### DETAILED DESCRIPTION OF THE INVENTION

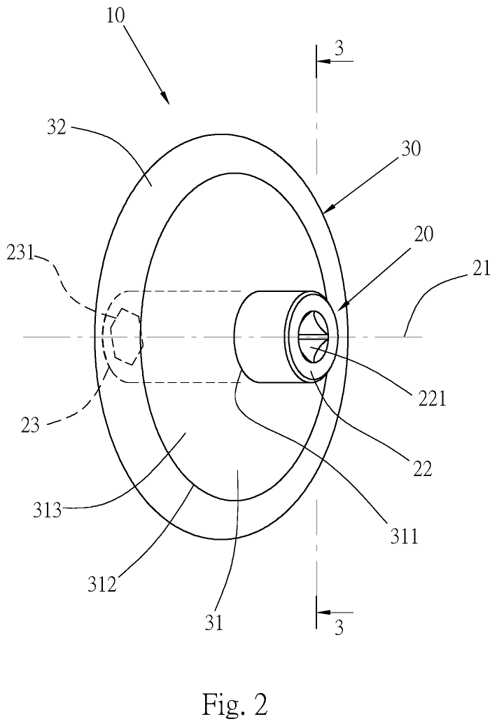

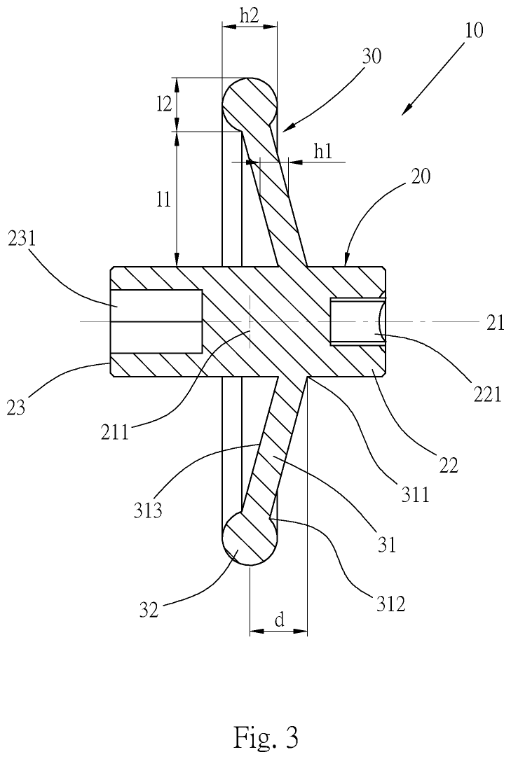

Please refer to FIG. 2 and FIG. 3, which show an inertial transmission device 10 provided by a first preferred embodiment of the present invention, the inertial transmission device 10 mainly includes a center element 20 and an inertial element 30.

The center element 20 has an axial direction 21 and two ends, one of the ends is a driving end 22, and an end surface thereof is provided with a square hole 221. The driving end 22 is connected to a tool T. The tool of this embodiment is a pneumatic tool, which can also be other types of tools such as a power tool as long as the device is capable of producing an output force through rotational action. The center element 20 is made to be capable of rotating with the axial direction 21 as a center. The other end of the center element 20 is an output end 23 with an end surface provided with a hexagonal hole 231. The output end 23 is sleeved with a workpiece or connected with a tool to generate a tightening or loosening rotational action.

The inertial element 30 is integrally formed with the center element 20 in this embodiment, and has a connecting portion 31 and an inertia portion 32. The connecting portion 31 is an annular disc having an inner edge 311 and an outer edge 312, and the inner edge 311 is connected to a peripheral surface of the center element 20. A cross section between the inner edge 311 and the outer edge 312 forms an inclined surface 313. The inclined surface 313 is inclined from the driving end 22 toward the output end 23, the inner edge 311 and the outer edge 312 have a positional difference d in the axial direction 21 of the center element 20, so that the outer edge 312 is closer to the output end 23 than the inner edge 311. In this embodiment, a position where the inner edge 311 is connected to the center element 20 is closer to the driving end 22, that is, between a central position 211 of the center element 20 and the driving end 22, but it is not limited thereto. The inertial portion 32 is ring-shaped, and annularly disposed at the outer edge 312 of the connecting portion 31, a thickness h2 of the inertial portion 32 is greater than a thickness h1 of the connecting portion 31, preferably the inertial portion 32 forms a part of the connecting portion 31 with the largest mass, that is, the inertia portion 32 forms the heaviest part of the entire inertial element 30. In this embodiment, a cross section of the inertia portion 32 is formed in a circular shape, and a periphery of the inertia portion 32 protrudes from disc surfaces of both sides of the connecting portion 31. A vertical length 11 of the connecting portion 31 perpendicular to the axial direction 21 of the center element 20 is greater than a vertical length 12 of the inertia portion 32. Thereby, the present invention makes the inertial portion 32 with a larger mass closer to the output end 23 of the center element 20 than the connecting portion 31, so that the inertial portion 32 is capable of generating a larger mass, and thus when the center element 20 rotates, a larger moment of inertia (rotational inertia) close to the output end 23 can be generated.

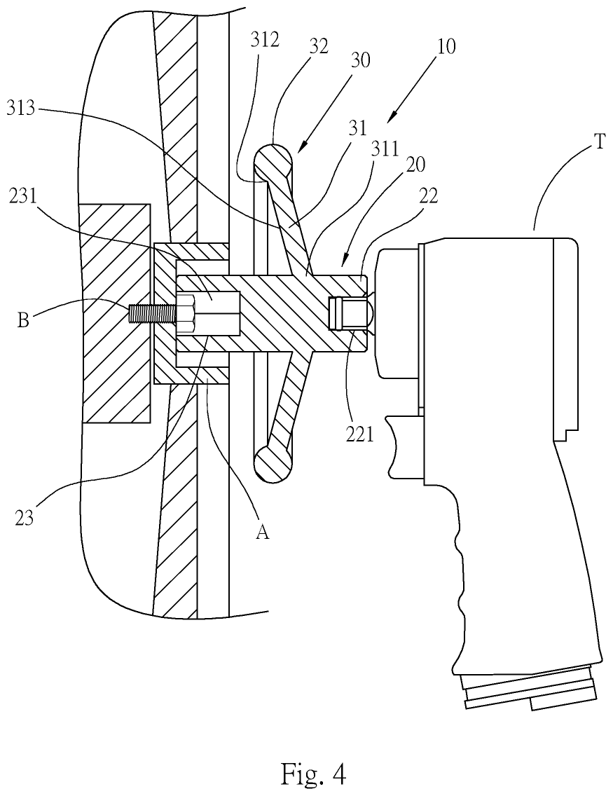

Please refer to FIG. 4, when using the present invention, the square hole 221 of the driving end 22 of the center element 20 is installed on a tool T, and the hexagonal hole 231 of the output end 23 is sleeved around a workpiece B. Then, the tool T generates a rotational momentum, and rotates with the axial direction 21 of the center element 20 as a center, the center element 20 and the inertial element 30 are synchronously driven by the tool T to generate rotation, and a tightening or loosening action can be performed on the workpiece B. The present invention makes the inertia portion 32 closer to the output end 23, so when the inertia element 30 rotates, the inertia portion 32 will generate a moment of inertia close to the output end 23. Because the moment of inertia is close to the output end 23, the moment of inertia is capable of exerting to the output end 23 more effectively and without loss, and a larger rotational torque is generated to the workpiece B, so that the tool T is capable of driving the workpiece B more effectively.

Furthermore, since the inner edge 311 of the connecting portion 31 of the inertial element 30 is closer to the driving end 22 than the outer edge 312, and is relatively far away from the output end 23, the inertial element 30 will be at a position far away from the output end 23 when rotating, and thus a distance between the inertial element 30 and a peripheral portion A of the workpiece B is increased, and the inertial element 30 will not be interfered by the operating environment. With this structure, the output end 23 of the inertial transmission device 10 can extend into a deeper position in an operating space, and is more suitable for sleeving with workpieces at deep position.

In addition, the connecting portion 31 and the inertia portion 32 approach the output end 23 in a direction from the inner edge 311 to the outer edge 312, so that an outer side of the inertial element 30 is far away from the driving end 22. When users operate the tool T, a chance of touching the inertia member 30 can be reduced, and operation safety is improved.

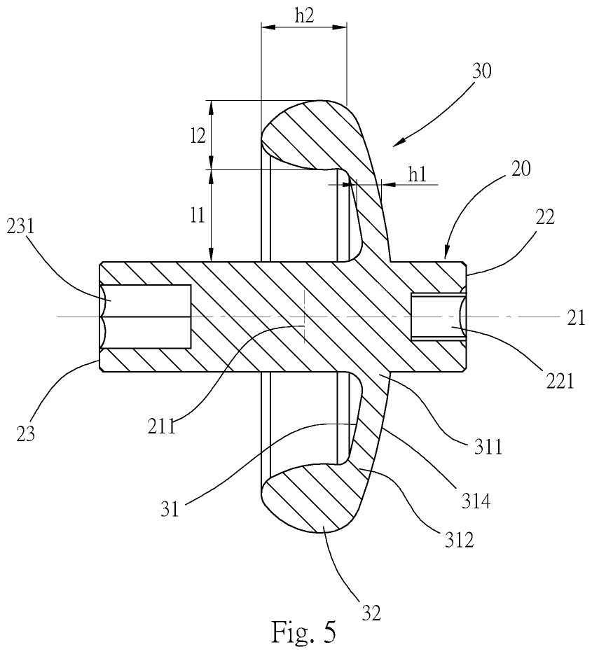

Please refer to FIG. 5, which is the inertial transmission device 10 provided by a second preferred embodiment of the present invention. The main structure is the same as that of the first preferred embodiment, and the same parts will not be described in detail, wherein:

the connecting portion 31 of the inertial element 30 is formed as an annular disc between the inner edge 311 and the outer edge 312, a cross section between the inner edge 311 and the outer edge 312 is formed as a curved surface 314, the inertial portion 32 also forms the heaviest part of the entire connecting portion 31 and is close to the output end 23, a thickness of the inertia portion 32 is greater than a thickness of the connecting portion 31, a periphery of the inertia portion 32 protrudes from a disc surface of a side of the connecting portion 31 and protrudes toward the output end 23, so that a mass of the inertia portion 32 is closer to the output end 23, and thus an overall moment of inertia (rotational inertia) is closer to the output end 23.

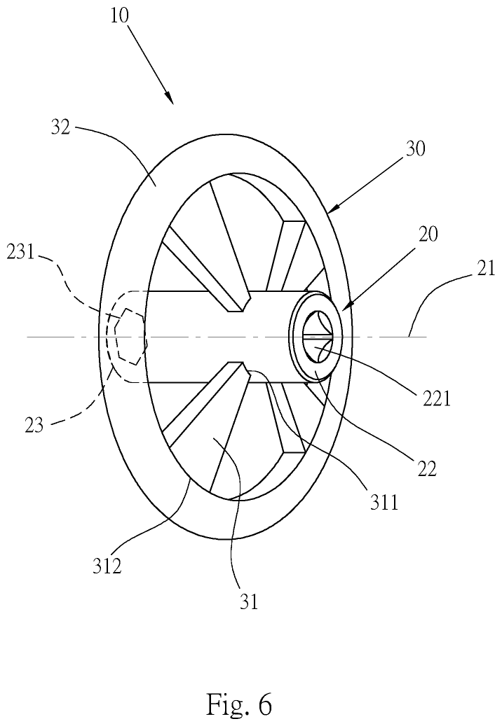

Please refer to FIG. 6, which is the inertial transmission device 10 provided by a third preferred embodiment of the present invention. The main structure is the same as that of the first preferred embodiment, and the same parts will not be described in detail, wherein:

the connecting portion 31 of the inertial element 30 is provided with four ribs disposing at equal intervals between the inner edge 311 and the outer edge 312, the inner edge 311 is connected to the center element 20, the outer edge 312 is connected to the inertia portion 32 partially, so that a weight of the connecting portion 31 can be reduced, and an overall moment of inertia (rotational inertia) of the inertia member 30 can be closer to the output end 23.

It is to be understood that the above description is only a preferred embodiment of the present invention and is not used to limit the present invention, and changes in accordance with the concepts of the present invention may be made without departing from the spirit of the present invention, for example, the equivalent effects produced by various transformations, variations, modifications and applications made to the configurations or arrangements shall still fall within the scope covered by the appended claims of the present invention.

What is claimed is:

1. An inertial transmission device including:
a center element having an axial direction and two ends, one of the ends being a driving end and the other end being an output end, the center element being capable of rotating with the axial direction as a center; and
an inertial element having a connecting portion and an inertia portion, the connecting portion having an inner edge and an outer edge, the inner edge being connected to the center element, in the axial direction of the center element, the inner edge and the outer edge of the connecting portion having a positional difference, the outer edge being closer to the output end of the center element than the inner edge, and the inertia portion being disposed at the outer edge of the connecting portion.

2. The inertial transmission device as claimed in claim 1, wherein the inertia portion is ring-shaped, and annularly disposed at the outer edge of the connecting portion.

3. The inertial transmission device as claimed in claim 1, wherein the connecting portion is formed as an annular disc.

4. The inertial transmission device as claimed in claim 1, wherein the connecting portion is formed as at least two ribs disposing at equal intervals.

5. The inertial transmission device as claimed in claim 1, wherein a cross section between the inner edge and the outer edge of the connecting portion forms an inclined surface.

6. The inertial transmission device as claimed in claim 1, wherein a cross section between the inner edge and the outer edge of the connecting portion forms a curved surface.

7. The inertial transmission device as claimed in claim 1, wherein a thickness of the inertia portion is greater than a thickness of the connecting portion.

8. The inertial transmission device as claimed in claim 7, wherein a periphery of the inertia portion protrudes from two sides of the connecting portion.

9. The inertial transmission device as claimed in claim 7, wherein a periphery of the inertia portion protrudes from one side of the connecting portion, and protrudes in a direction toward the output end of the center element.

10. The inertial transmission device as claimed in claim 1, wherein the inner edge of the connecting portion of the inertial element is closer to the driving end of the center element.

11. The inertial transmission device as claimed in claim 1, wherein the driving end is provided with a polygonal hole, and the output end is provided with a polygonal hole.

12. The inertial transmission device as claimed in claim 1, wherein the center element, the inertial element, and the inertia portion are integrally formed.
